(19) United States
(12) Patent Application Publication
(10) Pub. No.: US 2026/0225463 A1
(43) Pub. Date: Aug. 6, 2026

(54) CONTROL SYSTEM FOR VEHICLE

(71) Applicant: Toyota Jidosha Kabushiki Kaisha, Toyota-shi (JP)

(72) Inventors: Kazuma AOKI, Toyota-shi (JP); Takeshi Kitahata, Toyota-shi (JP); Noritaka Takuda, Okazaki-shi (JP); Hiroto Amada, Nagakute-shi (JP); Tatsuya Kawamura, Nagoya-shi (JP); Takeshi Ishiwada, Anjo-shi (JP)

(73) Assignee: Toyota Jidosha Kabushiki Kaisha, Toyota-shi (JP)

(21) Appl. No.: 19/424,710

(22) Filed: Dec. 18, 2025

(30) Foreign Application Priority Data
Jan. 10, 2025 (JP) 2025-004323

(51) Int. Cl. B60L 15/20

(52) U.S. Cl. CPC B60L 15/20; B60L 2240/16; B60L 2240/30; B60L 2240/461; B60L 2240/48

(57) ABSTRACT

A control system for determining a torsion of a drive shaft connected to a wheel. A torsion determiner determines a torsion of the drive shaft in a case that a rotary member connected to the drive shaft is halted by a parking lock mechanism, braking torque applied to the wheel by a brake is equal to or less than the predetermined torque, and that an inclination of the vehicle is equal to or greater than a predetermined angle. A motor controller controls a motor to generate an assist torque counteracting a torsional torque acting on the drive shaft when allowing the rotary member to rotate by the parking lock mechanism.

### CROSS-REFERENCE TO RELATED APPLICATIONS

The present disclosure claims the benefit of Japanese Patent Application No. 2025-004323 filed on January 10, 2025 with the Japanese Patent Office, the entire contents of which are hereby incorporated by reference.

### BACKGROUND

### Technical Field

The embodiment of the present disclosure relates to the art of a control system for a vehicle in which a drive shaft is selectively locked by a parking lock mechanism.

### Discussion of the Related Art

In the prior art, there has been known control systems for a vehicle having a parking lock mechanism, in which a rotation of a drive shaft connected to a wheel is stopped by engaging a parking pawl with a parking gear interlocked with the wheel, and in which the drive shaft is allowed to rotate by disengaging the parking pawl from the parking gear.

For example, JP-B-3454009 discloses a parking lock device in which a shift lever operated by a driver and a parking pawl are mechanically connected to each other, and a control apparatus thereof. In the parking lock device described in JP-B-3454009, a large operating force is required to operate a shift lever to disengage the parking pawl from the parking gear, if a load acting on a meshing surface between the parking gear and the parking pawl is large. Therefore, the control apparatus described in JP-B-3454009 is configured to reduce the meshing load between the parking lock gear and the parking pawl by driving a motor as prime mover of the vehicle when an inclination angle of the vehicle in the front-rear direction is equal to or greater than the predetermined angle.

JP-A-2020-100312 discloses a control device applied to a vehicle having a parking lock mechanism, a foot brake device that is actuated when a brake pedal is depressed by a driver to apply a braking force to a wheel, and an electric parking brake that is actuated in conjunction with the parking lock mechanism to continuously apply a braking force to the wheel. The control device described in JP-A-2020-100312 is configured to apply the braking force continuously to the wheel by the foot brake device even if the brake pedal is released by the driver after a shift lever is moved to a parking position and before the braking force is applied to the wheels by the electric parking brake, if an inclination angle of a road surface is equal to or greater than a predetermined angle.

JP-A-2015-027134 discloses a vehicular control apparatus configured to prevent shocks when releasing a front drive shaft locked by a parking lock mechanism. The vehicle described in JP-A-2015-027134 comprises a front motor connected to a front drive shaft, and a rear motor connected to a rear drive shaft. Specifically, the vehicular control apparatus taught by JP-A-2015-027134 is configured to calculate an amount of torsional stress acting the front drive shaft based on an amount of changes in rotational angles of the front motor and the rear motor from a point at which the front drive shaft was locked by the parking lock mechanism or a point at which the braking force applied to the wheel was canceled, and to output the torque corresponding to the amount of torsional stress from the front motor.

When the vehicle described in JP-B-3454009 having the parking lock mechanism is stopped on a slope, the meshing load between the parking lock gear and the parking pawl is increased. In this situation, therefore, the control apparatus described in JP-B-3454009 releases the parking lock device while reducing the meshing load acting between the parking lock gear and the parking pawl by driving a motor as a prime mover. However, a magnitude of torque acting on the drive shaft connected to the wheel differs depending on e.g., a condition to apply the braking torque to the wheel, and a length of time until the braking torque is applied to the wheel after actuating the parking lock mechanism. In other words, the meshing load acting between the parking lock gear and the parking pawl may not be determined based only on a road gradient. For example, given that the meshing load acting between the parking lock gear and the parking pawl is smaller than the load determined based on the road gradient and that the motor generates the torque based on the road gradient, the output torque of the motor may be excessive.

The control device described in JP-A-2020-100312 is configured such that the drive shaft is not twisted by applying the braking torque to the wheels by the foot brake device until the braking torque of the electric parking brake acts on the wheel. That is, the braking torque is always applied to the wheel as long as the wheel is halted by the parking lock mechanism. However, the drive shaft may be twisted in a case that the electric parking brake cannot be activated, in a case that the vehicle is not provided with the electric parking brake, or in a case that the control device does not have a function to apply the braking torque to the wheel by the foot brake device until the braking torque generated by the electric parking brake acts on the wheel. The control device described in JP-A-2020-100312 does not have a function to determine that the drive shaft is twisted. Therefore, the vehicle may be vibrated when the torsion of the drive shaft is eliminated by releasing the parking lock mechanism.

The vehicular control apparatus described in JP-A-2015-027134 is configured to determine the amount of torsional stress acting on the front drive shaft based on the amounts of change in the rotational angles of the front motor and the rear motor. Therefore, the vehicular control apparatus described in JP-A-2015-027134 cannot determine a torsion of the drive shaft in front-drive layout vehicles and rear-drive layout vehicles in which the motor is connected only to a pair of front wheels or rear wheels. Thus, the type of vehicles possible to determine a torsion of the drive shaft by the vehicular control apparatus described in JP-A-2015-027134 are limited.

### SUMMARY

The embodiment of the present disclosure has been conceived noting the foregoing technical problems, and it is therefore an object of the present disclosure to provide a control system for a vehicle configured to determine a torsion of a drive shaft connected to a wheel.

According to one aspect of the present disclosure, there is provided a control system for a vehicle, comprising: a drive shaft in which one end thereof is joined to a wheel; a motor that applies a torque to the drive shaft; a parking lock mechanism that stops a rotation of a predetermined rotary member arranged between the motor and the drive shaft by locking the rotary member, and that allows the rotary member to rotate by releasing the rotary member; and a brake device that applies a braking torque to the wheel. In order to achieve the above-explained objective, according to one aspect of the present disclosure, a controller for controlling the motor comprises: a parking determiner that determines whether the rotation of the rotary member is stopped by the parking lock mechanism; a brake determiner that determines whether the braking torque applied to the wheel by the brake device is equal to or less than a predetermined torque; an inclination angle determiner that determines whether an inclination angle of the vehicle in a pitching direction is equal to or greater than a predetermined angle; a torsion determiner that determines a torsion of the drive shaft in a case that the rotation of the rotary member is stopped by the parking lock mechanism, that the braking torque applied to the wheel by the brake device is equal to or less than the predetermined torque, and that the inclination angle of the vehicle in the pitching direction is equal to or greater than the predetermined angle; and a motor controller that controls the motor to generate an assist torque in a direction to counteract a torsional torque acting on the drive shaft when allowing the rotary member to rotate by the parking lock mechanism, in a case that the torsion of the drive shaft is determined.

In a non-limiting embodiment, the torsion determiner may be configured to determine the torsion of the drive shaft in a case that the rotation of the rotary member is stopped by the parking lock mechanism, and that a length of time in which the braking torque applied to the wheel by the brake device is equal to or less than a predetermined torque is equal to or longer than a predetermined period of time.

In a non-limiting embodiment, the predetermined period of time is set shorter with an increase in the inclination angle of the vehicle.

In a non-limiting embodiment, the control system may further comprise a wheel speed detector that detects a rotational speed of the wheel. In addition, the torsion determiner may be configured to determine the torsion of the drive shaft in a case that the rotational speed of the wheel after stopping the rotation of the rotary member by the parking lock mechanism is equal to or higher than a predetermined speed.

In a non-limiting embodiment, the control system may further comprise an acceleration detector that detects a longitudinal acceleration of the vehicle. In addition, the torsion determiner may be configured to determine the torsion of the drive shaft in a case that a difference between a maximum value and a minimum value of the acceleration of the vehicle after stopping the rotation of the rotary member by the parking lock mechanism is equal to or greater than a predetermined value.

According to another aspect of the present disclosure, there is provided a control system for a vehicle comprising: a drive shaft in which one end thereof is joined to a wheel; a motor that applies a torque to the drive shaft; and a parking lock mechanism that stops a rotation of a predetermined rotary member arranged between the motor and the drive shaft by locking the rotary member, and that allows the rotary member to rotate by releasing the rotary member. According to another aspect of the present disclosure, the control system comprises: a wheel speed detector that detects a rotational speed of the wheel; and a controller that controls the motor. In order to achieve the above-explained objective, according to another aspect of the present disclosure, the controller comprises: a parking determiner that determines whether the rotation of the rotary member is stopped by the parking lock mechanism; an inclination angle determiner that determines whether an inclination angle of the vehicle in a pitching direction is equal to or greater than a predetermined angle; a rotational speed determiner that determines whether a rotational speed of the wheel is equal to or higher than a predetermined speed; a torsion determiner that determines a torsion of the drive shaft in a case that the rotation of the rotary member is stopped by the parking lock mechanism, that the inclination angle of the vehicle in the pitching direction is equal to or greater than the predetermined angle, and that the rotational speed of the wheel after stopping the rotation of the rotary member by the parking lock mechanism is equal to or higher than the predetermined speed; and a motor controller that controls the motor to generate an assist torque in a direction to counteract a torsional torque acting on the drive shaft when allowing the rotary member to rotate by the parking lock mechanism, in a case that the torsion of the drive shaft is determined.

According to still another aspect of the present disclosure, there is provided a control system for a vehicle comprising: a drive shaft in which one end thereof is joined to a wheel; a motor that applies a torque to the drive shaft; and a parking lock mechanism that stops a rotation of a predetermined rotary member arranged between the motor and the drive shaft by locking the rotary member, and that allows the rotary member to rotate by releasing the rotary member. According to still another aspect of the present disclosure, the control system comprises: an acceleration detector that detects a longitudinal acceleration of the vehicle; and a controller that controls the motor. In order to achieve the above-explained objective, according to still another aspect of the present disclosure, the controller comprises: a parking determiner that determines whether the rotation of the rotary member is stopped by the parking lock mechanism; an inclination angle determiner that determines whether an inclination angle of the vehicle in a pitching direction is equal to or greater than a predetermined angle; a torsion determiner that determines a torsion of the drive shaft in a case that the rotation of the rotary member is stopped by the parking lock mechanism, that the inclination angle of the vehicle in the pitching direction is equal to or greater than the predetermined angle, and that a difference between a maximum value and a minimum value of the acceleration of the vehicle after stopping the rotation of the rotary member by the parking lock mechanism is equal to or greater than a predetermined value; and a motor controller that controls the motor to generate an assist torque in a direction to counteract a torsional torque acting on the drive shaft when allowing the rotary member to rotate by the parking lock mechanism, in a case that the torsion of the drive shaft is determined.

In a non-limiting embodiment, the controller may further comprise an abnormality determiner that determines a fact that the braking torque applied to the wheel by the brake device is out of control. In addition, the torsion determiner may be further configured not to determine the torsion of the drive shaft in a case that the braking torque applied to the wheel by the brake device is out of control.

As described, the control system according to one aspect of the present disclosure determines that the drive shaft is twisted in the situation where the rotation of the rotary member arranged between the motor and the drive shaft is stopped by the parking lock mechanism, the braking torque applied to the wheel by the brake device is equal to or less than the predetermined torque, and the inclination angle of the vehicle in the pitching direction is equal to or greater than the predetermined angle. Therefore, when releasing the parking lock mechanism, it is possible to determine whether or not to generate an assist torque by the motor so as to cancel the torsional torque accumulated in the drive shaft. For this reason, when releasing the parking lock mechanism, the assist torque is not generated by the motor unnecessarily, and hence the vehicle will not be vibrated by such unnecessary assist torque.

As also described, the control system according to another aspect of the present disclosure determines that the drive shaft is twisted in the situation where the rotation of the rotary member arranged between the motor and the drive shaft is stopped by the parking lock mechanism, the inclination angle in the pitching direction of the vehicle is equal to or greater than the predetermined angle, and the rotational speed of the wheel after stopping the rotation of the rotary member by the parking lock mechanism is equal to or higher than the predetermined speed. Therefore, the torsion of the drive shaft will not be determined erroneously in a situation where the wheel is not allowed to rotate by a traveling resistance and frictional resistances of rotary members arranged upstream of the wheel. For this reason, the assist torque will not be generated by the motor when the parking lock mechanism is released. That is, the vehicle will not be vibrated by the assist torque of the motor when the parking lock mechanism is released. In other words, the torsion of the driveshaft may be determined based on the actual behavior of the vehicle. Therefore, it is possible to improve the determination accuracy of the torsion of the drive shaft.

As also described, the control system according to still another aspect of the present disclosure determines that the drive shaft is twisted in the situation where the rotation of the rotary member arranged between the motor and the drive shaft is stopped by the parking lock mechanism, the inclination angle in the pitching direction of the vehicle is equal to or greater than the predetermined angle, and the difference between the maximum value and the minimum value of the acceleration of the vehicle after stopping the rotation of the rotary member by the parking lock mechanism is equal to or greater than the predetermined value. That is, it is also possible to determine the torsion of the drive shaft based on detection signals of the longitudinal acceleration and the inclination angle of the vehicle transmitted from the acceleration detector. Therefore, it is not necessary to arrange an additional sensor for determining the torsion of the drive shaft. For this reason, the size of the vehicle is not increased by the additional sensor, and in addition, it is possible to prevent complication of data-processing of the sensor.

### BRIEF DESCRIPTION OF THE DRAWINGS

Features, aspects, and advantages of exemplary embodiments of the present disclosure will become better understood with reference to the following description and accompanying drawings, which should not limit the disclosure in any way.

FIG. 1 is a schematic illustration showing one example of a structure of the vehicle to which the control system according to the exemplary embodiment of the present disclosure is applied;

FIG. 2 is a block diagram showing functions of the controller;

FIG. 3 is a flow chart showing one example of a routine for setting a torsion flag based on an inclination angle, and conditions of an EPB, and a brake device;

FIG. 4 is a flow chart showing one example of a routine for determining whether the EPB is in a braking condition or a non-braking condition;

FIG. 5 is a flow chart showing one example of a routine for setting the torsion flag based on a length of time after the EPB and the brake device are brought into the non-braking condition;

FIG. 6 is a time chart showing changes in the inclination angle, an operating mode, a state of a brake pedal, a condition of the EPB, a count value of a first counter, a torque of the EPB, a count value of a second counter, and a state of the torsion flag during execution of the routines shown in FIGS. 4 and 5;

FIG. 7 is a flow chart showing one example of a routine for setting the torsion flag based on a wheel speed;

FIG. 8 is a graph showing a relation between a torsional torque and a difference between a maximum value and a minimum value of longitudinal acceleration of the vehicle;

FIG. 9 is a flowchart showing one example of a routine for setting the torsion flag based on a difference between the maximum value and the minimum value of the longitudinal acceleration of the vehicle; and

FIG. 10 is a flowchart one example of a routine for setting an inhibition flag.

### DETAILED DESCRIPTION OF THE EMBODIMENT(S)

An embodiment of the present disclosure will now be explained with reference to the accompanying drawings. Note that the embodiments shown below are merely examples of the present disclosure, and do not limit the present disclosure.

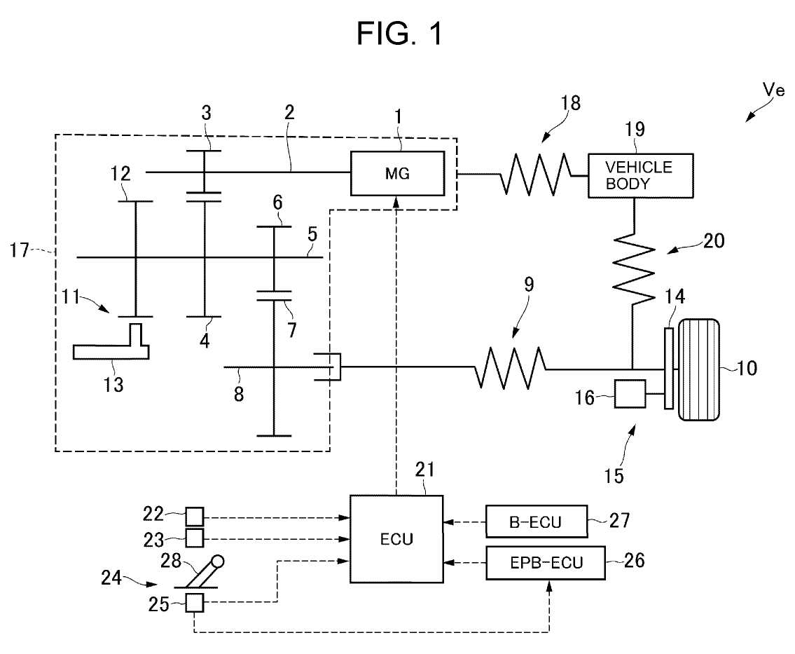

Referring now to FIG. 1, there is shown one example of a structure of a vehicle Ve to which the control system according to the exemplary embodiment of the present disclosure is applied. The vehicle Ve shown in FIG. 1 is an electric vehicle comprising a motor (referred to as MG in FIG. 1) 1 as a prime mover. As the motor 1, a motor serving as a prime mover of conventional electric vehicles and hybrid vehicles may be employed. The motor 1 is operated as a motor to generate a driving torque by supplying electric power thereto from a power storage device (not shown), and as a generator to translate a kinetic power of an output shaft 2 thereof into electric power at least partially by rotating the output shaft 2 passively. For example, a permanent magnet synchronous motor or an induction motor may be adopted as the motor 1.

A first drive gear 3 is mounted on the output shaft 2 of the motor 1, and a first driven gear 4 is mounted on an intermediate portion of the intermediate shaft 5 extending parallel to the output shaft 2 of the motor 1 to be meshed with the first drive gear 3. The first driven gear 4 is diametrically larger than the first drive gear 3 so that the first drive gear 3 and the first driven gear 4 serve as a reduction gear pair.

A second drive gear 6 is mounted on one end of the intermediate shaft 5, and a second driven gear 7 is mounted on an output shaft 8 extending parallel to the output shaft 2 and the intermediate shaft 5 to be meshed with the second drive gear 6. The second driven gear 7 is diametrically larger than the second drive gear 6 so that the second drive gear 6 and the second driven gear 7 also serve as a reduction gear pair. One end of the drive shaft 9 is joined to the output shaft 8 to rotate integrally therewith, and a wheel 10 is joined to the other end of the drive shaft 9.

The vehicle Ve is provided with a parking lock mechanism 11 that stops the rotation of the intermediate shaft 5 by locking the intermediate shaft 5, and allows the intermediate shaft 5 to rotate by releasing the intermediate shaft 5. A structure of the parking lock mechanism 11 is similar to those of parking lock mechanisms employed in the conventional vehicles. Specifically, the parking lock mechanism 11 comprises a parking lock gear 12 mounted on the other end of the intermediate shaft 5, a parking pawl 13 selectively engaged with the parking lock gear 12, and an actuator (not shown) for rotating the parking pawl 13. When a shift lever 28 of an after-mentioned shifting device 24 is moved to a parking position, the parking pawl 13 is rotated by the actuator to be meshed with the parking lock gear 12 thereby stopping a rotation of the parking lock gear 12. As a result, the rotation of the drive shaft 9 connected to the parking lock gear 12 through the intermediate shaft 5 in a torque transmittable manner is stopped.

A braking torque is applied to the wheel 10 by a brake device 14 according to a depression of a brake pedal (not shown) operated by a driver. As the brake device 14, brake devices arranged in the conventional vehicles may be employed. For example, a disk brake that applies a braking torque to the wheel 10 by clamping a brake rotor rotating integrally with the wheel 10 by a brake pad, and a drum brake that applies a braking torque to the wheel 10 by pressing a brake shoe from inside of a drum rotating integrally with the wheel 10 may be adopted as the brake device 14. A clamping force of the brake pad and a pushing force of the brake shoe may be controlled by an actuator (not shown) that generates a hydraulic pressure or an electromagnetic force in accordance with a depression of the brake pedal.

The vehicle Ve further comprises an electric parking brake (hereinafter, referred to as EPB) 15. When the shift lever 28 of the shifting device 24 is moved to the parking position, a motor 16 is activated to actuate a caliper or a brake shoe (neither of which are shown) of the EPB 15 to apply a braking torque to the wheel 10. Whereas, when the shift lever 28 of the shifting device 24 is moved to a position other than the parking position, the EPB 15 reduces the braking torque applied to the wheel 10. In order to fit the motor 16 easily into the vehicle Ve, the motor 16 may be arranged in a vehicle body, and the motor 16 and the caliper or the brake shoe may be connected to each other through a wire. In this case, the caliper and the brake shoe are actuated by rotating the motor 16 to wind up the wire. The brake device 14 and the EPB 15 serve as a brake device of the exemplary embodiment of the present disclosure.

In the vehicle Ve, the motor 1 and a gear train for delivering a torque from the motor 1 to the output shaft 8 are held in a case 17, and the case 17 is connected to a vehicle body 19 through a mount 18. The wheel 10 is connected to the vehicle body 19 through a suspension 20.

An operating mode of the vehicle Ve is allowed to be shifted to a parking mode by moving the shift lever 28 to the parking position while depressing the brake pedal. In the parking mode, a rotation of the intermediate shaft 5 is stopped by the parking lock mechanism 11, and a braking torque is applied to the wheel 10 by the EPB 15.

When the above-mentioned shifting operation is executed by the driver to shift the operating mode to the parking mode, the rotation of the intermediate shaft 5 is stopped by the parking lock mechanism 11 before the braking torque is applied to the wheel 10 by the EPB 15. In this situation, given that the vehicle Ve is parked on a slope or that the vehicle Ve is parked such that some of the wheels 10 is/are stopped on a curb, the vehicle Ve is inclined in the pitching direction. In this case, if the driver returns the brake pedal before the braking torque is applied to the wheel 10 by the EPB 15, the wheel 10 will rotate even though the rotation of an input section of the drive shaft 9 is stopped. In addition, if the EPB 15 cannot function properly for some reason, the wheel 10 will also rotate after returning the brake pedal even though the rotation of the input section of the drive shaft 9 is stopped. As a result, the drive shaft 9 is twisted. That is, the drive shaft 9 is subjected to a torque (i.e., a torsional torque) in accordance with an elastic modulus and a torsion angle thereof.

If the operating mode is shifted to a mode other than the parking mode in the situation where the drive shaft 9 is twisted, the torsion of the drive shaft 9 is eliminated when the intermediate shaft 5 locked by the parking lock mechanism 11 is released, and the torsional torque acting on the drive shaft 9 propagates toward the motor 1. As a result, the torque transmitted to the motor 1 is pulsated in accordance with the elastic modulus of the drive shaft 9 thereby vibrating the vehicle Ve.

In addition, the suspension 20 is vibrated vertically by the pulsation of the torque of the drive shaft 9 thereby vibrating the vehicle Ve.

In the situation where the drive shaft 9 is twisted, such vibrations of the vehicle Ve may be suppressed by generating an assist torque by the motor 1 to counteract the torsional torque acting on the drive shaft 9, when the intermediate shaft 5 is released by the parking lock mechanism 11.

Nonetheless, if the motor 1 generates the assist torque in a situation where the drive shaft 9 is not twisted, the assist torque is transmitted to the wheel 10 without being cancelled by the torsional torque. In this case, therefore, the vehicle Ve will be vibrated by the assist torque.

Therefore, the control system according to the exemplary embodiment of the present disclosure is configured to generate the assist torque by the motor 1 when torsion of the drive shaft 9 is determined. To this end, the control system is provided with an electronic control unit (hereinafter abbreviated as the ECU) 21 serving as a controller for controlling the motor 1. The ECU21 comprises a microcomputer configured to control an output torque of the motor 1 on the basis of incident signals using calculation expressions stored in advance.

The ECU 21 is connected with an acceleration sensor 22 as an acceleration detector that detects a longitudinal acceleration of the vehicle Ve, a wheel speed sensor 23 as a wheel speed detector that detects a rotational speed (or rotational angle) of the wheel 10, and a shift sensor 25 that detects the operating mode selected by the shifting device 24, so that signals are transmitted to the ECU 21 from the sensors 22, 23, and 25. In addition, an EPB-ECU 26 for controlling the EPB 15 and a B-ECU 27 for controlling the brake device 14 are also connected with the ECU 21 so that signals are also transmitted to the ECU 21 from the EPB-ECU 26 and the B-ECU 27.

For example, a so-called momentary shifting device may be adopted as the shifting device 24. In this case, when the shift lever 28 is moved from the initial position to a desired position, a signal corresponding to the position of the shift lever 28 is transmitted to the ECU 21 from the shift sensor 25, and when the shift lever 28 is released, the shift lever 28 returns to the initial position. As an option, the shifting device 24 may be provided with a parking button for selecting a parking mode, and the shift sensor 25 may be activated by pressing the parking button.

The EPB-ECU 26 is connected with the shift sensor 25. Specifically, the EPB-ECU 26 is configured to determine whether the EPB 15 is activated based on a signal transmitted from the shift sensor 25, and to transmit a command signal to the ECU 21 or the motor 16 based on a determination result. For example, a signal representing a depression of the brake pedal, a signal representing a pedal force applied to the brake pedal, and a signal representing a pressure of a master cylinder are transmitted to the B-ECU27. Otherwise, a detection signal of a hydraulic pressure or an electromagnetic force for generating a braking torque by the brake device 14 is transmitted to the B-ECU27. Specifically, the B-ECU27 is configured to calculate a braking torque to be generated by the brake device 14 based on the incident signals, and to transmit a command signal to the ECU 21 based on the calculated braking torque.

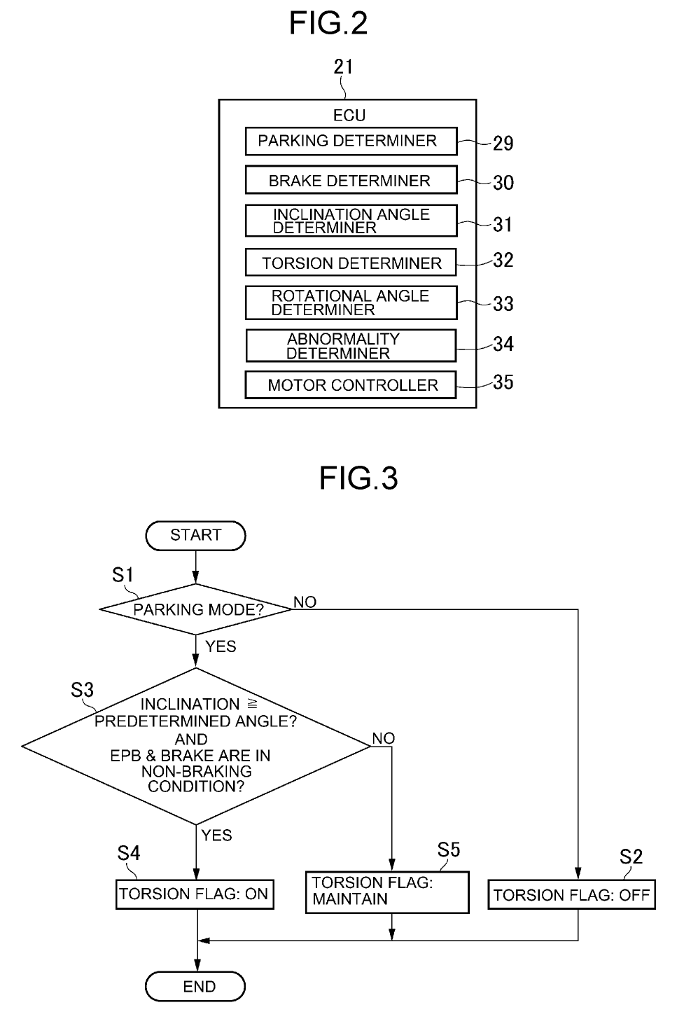

Turning to FIG. 2, there are shown functions of the ECU 21. As shown in FIG. 2, the ECU 21 comprises a parking determiner 29, a brake determiner 30, an inclination angle determiner 31, a torsion determiner 32, a rotational speed determiner 33, an abnormality determiner 34, and a motor controller 35. The parking determiner 29 is configured to determine whether the vehicle Ve is in the parking mode in which the rotation of the intermediate shaft 5 is stopped by the parking lock mechanism 11. In other words, the parking determiner 29 is configured to determine whether the intermediate shaft 5 is locked by the parking lock mechanism 11. Specifically, the parking determiner 29 determines that the vehicle Ve is in the parking mode based on a fact that a predetermined time has elapsed since the shift lever 28 was moved to the parking position, or a fact that a command signal for actuating the parking pawl 13 is transmitted to the actuator.

The brake determiner 30 is configured to determine whether a braking torque applied to the wheel 10 is equal to or less than a predetermined torque. Specifically, the brake determiner 30 determines whether the braking torque applied to the wheel 10 is equal to or less than a predetermined torque based on the signals transmitted from the EPB-ECU 26 and the B-ECU 27 to the ECU 21. To this end, the predetermined torque may be set to a magnitude by which the wheel 10 will not rotate given that the vehicle Ve is stopped on a road at a predetermined gradient determined based on the specifications of the vehicle Ve.

The inclination angle determiner 31 is configured to determine whether the inclination angle of the vehicle Ve in the pitching direction is equal to or greater than a predetermined angle. Specifically, the inclination angle determiner 31 determines whether or not the inclination angle of the vehicle Ve is equal to or greater than the predetermined angle based on a longitudinal acceleration of the vehicle Ve detected by the acceleration sensor 22. To this end, the predetermined angle is set to an angle at which the wheel 10 will not rotate even if the braking torque is not applied thereto. For example, the predetermined angle may be determined based on a load acting in the longitudinal direction of the vehicle Ve in accordance with the inclination angle and a weight of the vehicle Ve, and a rolling friction or resistance between the wheel 10 and the road surface.

The torsion determiner 32 is configured to determine whether or not the drive shaft 9 is twisted by executing the after-mentioned controls.

The rotational speed determiner 33 is configured to determine whether or not a rotational speed of the wheel 10 is equal to or higher than a predetermined speed. Specifically, the rotational speed determiner 33 calculates a rotational speed of the wheel 10 after the rotation of the intermediate shaft 5 is stopped by the parking lock mechanism 11 based on a detection value of the wheel speed sensor 23, and determines whether or not the rotational speed of the wheel 10 is equal to or higher than the predetermined speed. To this end, the predetermined speed is set to a level possible to determine a rotation of the wheel 10 based on a detection accuracy of the wheel speed sensor 23. Specifically, the rotational speed of the wheel 10 is calculated by differentiating an amount of change in a rotational angle of the wheel 10 detected by the wheel speed sensor 23. That is, the rotational speed determiner 33 determines whether or not the amount of change in the rotational angle of the wheel 10 within a predetermined control cycle time is a predetermined amount of change.

The abnormality determiner 34 is configured to determine that the braking torque applied to the wheel 10 by the brake device 14 or the EPB 15 is out of control, or that the ECU 21 cannot receive the signal representing braking torque. Specifically, the abnormality determiner 34 determines whether or not a signal representing a malfunction of the brake device 14 or the EPB 15 is transmitted from the EPB-ECU 26 or the B-ECU 27 to the ECU 21, and whether or not a communication error occurs between the EPB-ECU 26 or the B-ECU 27 and the ECU 21. In other words, the abnormality determiner 34 determines whether or not a precondition for generating the assist torque by the motor 1 is satisfied, and transmits a determination result to the torsion determiner 32.

The motor controller 35 is configured to control the motor 1 to generate the assist torque counteracting the torsional torque acting on the drive shaft 9 when allowing the intermediate shaft 5 to rotate by the parking lock mechanism 11, in the case that the torsion of the drive shaft 9 is determined by the torsion determiner 32.

Turning to FIG. 3, there is shown one example of a routine for determining torsion of the drive shaft 9. At step S1, the parking determiner 29 determines whether or not the parking mode is selected. As described above, such determination at step S1 may be made based on the fact that a predetermined period of time has elapsed since the shift lever 28 was moved to the parking position, or the command signal for actuating the parking pawl 13 is transmitted to the actuator.

If the parking mode is not selected so that the answer of the step S1 is NO, the routine progresses to step S2 to turn off a torsion flag representing torsion of the drive shaft 9. That is, the torsion determiner 32 determines that the drive shaft 9 is not twisted, and thereafter the routine returns. By contrast, if the parking mode is selected so that the answer of step S1 is YES, the routine progresses to step S3 to determine whether an absolute value of an inclination angle of the vehicle Ve is equal to or greater than a predetermined angle, and whether each of the EPB 15 and the brake device 14 is in a non-braking condition.

That is, it is determined at step S3 whether or not conditions to twist the drive shaft 9 are satisfied. At step S3, specifically, the brake determiner 30 and the inclination angle determiner 31 determines whether or not the wheel 10 is still allowed to rotate even through a rotation of the input section of the drive shaft 9 has been stopped. In other words, it is determined at step S3 whether the braking torque has not yet applied sufficiently to the wheel 10.

If the absolute value of the inclination angle of the vehicle Ve is equal to or greater than the predetermined angle and each of the EPB 15 and the brake device 14 is in the non-braking condition so that the answer of the step S3 is YES, the conditions to twist the drive shaft 9 are satisfied. In this case, therefore, the routine progresses to step S4 to turn on the torsion flag. That is, the torsion determiner 32 determines that the drive shaft 9 is twisted, and thereafter the routine returns.

By contrast, if the absolute value of the inclination angle of the vehicle Ve is less than the predetermined angle, or at least any one of the EPB 15 and the brake device 14 is in a braking condition so that the answer of step S3 is NO, the routine progresses to step S5 to maintain a state of the torsion flag to a state in the previous routine, and thereafter returns. Specifically, if the torsion flag was set to on in the previous routine, the torsion flag is maintained to on. By contrast, if the torsion flag was set to off in the previous routine, the torsion flag is maintained to off.

That is, even if the brake device 14 and the EPB 15 generate braking torque after the drive shaft 9 is twisted in the vehicle Ve being stopped in the parking mode, the wheels 10 are halted while being slightly rotated. At step S5, therefore, the torsion flag is maintained to the state in the previous routine.

Thus, in the parking mode, the torsion determiner 32 determines that the drive shaft 9 is twisted in the case that the rotation of the intermediate shaft 5 is stopped by the parking lock mechanism 11, that the inclination angle of the vehicle Ve is equal to or greater than the predetermined angle, and that neither the brake device 14 and EPB15 generate the braking torque or braking force. Therefore, when shifting the operating mode from the parking mode to other modes, it is possible to determine whether to generate the assist torque by the motor 1 so as to cancel the torsional torque acting on the drive shaft 9. For this reason, the assist torque will not be generated unnecessarily by the motor 1 when shifting the operating mode from the parking mode to other modes. In addition, the vehicle Ve will not be vibrated by the unnecessary assist torque.

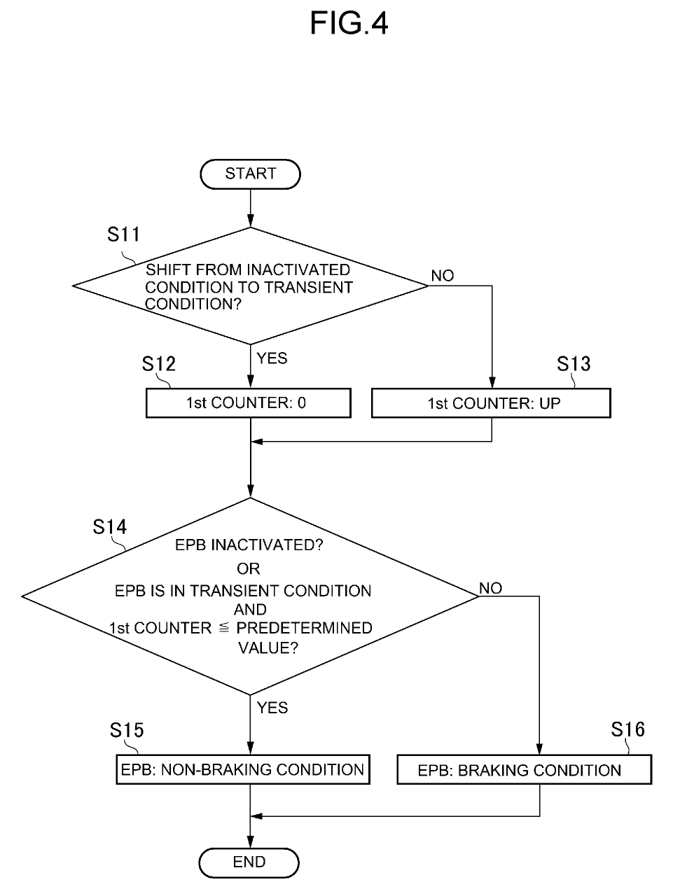

The braking torque applied to the wheel 10 by the EPB 15 begins to increase after the lapse of a predetermined time from the commencement of power supply to the motor 16. However, the vehicle Ve is not provided with a sensor for detecting the timing at which the braking torque starts acting on the wheel 10. Therefore, a fact that the braking torque generated by the EPB 15 has not yet been applied to the wheel 10, that is, the fact that the EPB 15 is in the non-braking condition may be determined if an elapsed time from the commencement of the power supply to the motor 16 is still shorter than a predetermined period of time. To this end, the routine shown in FIG. 4 is executed.

At step S11, it is determined whether it is a timing at which a condition of the EPB 15 in the non-braking condition is shifted from an inactivated condition in which the motor 16 is not energized and the braking torque is not applied to the wheel 10 by the brake device 14, to a transient condition in which the power supply to the motor 16 has been commenced but the braking torque has not yet been applied completely to the wheel 10 by the brake device 14. That is, it is determined at step S11 whether or not the EPB 15 has been activated to apply the braking torque to the released wheel 10. Such determination at step S11 may be made based on a fact that the power supply to the motor 16 has been started to apply the braking torque to the wheel 10.

If it is the timing at which the condition of the EPB 15 is shifted from the inactivated condition to the transient condition, in other words, if it is a timing at which the power supply to the motor 16 is commenced so that the answer of step S11 is YES, the routine progresses to step S12 to reset a count value of the first counter which is constantly incremented to zero. By contrast, if it is not the timing at which the condition of the EPB 15 is shifted from the inactivated condition to the transient condition so that the answer of step S11 is NO, the routine progresses to step S13 to increment the count value of the first counter. For example, the routine progresses from step S11 to step S13 in a case that the EPB 15 is in the inactivated condition, the transient condition, or an activated condition in which the wheel 10 is locked by the braking torque applied by the EPB 15. That is, the first counter is reset only at the timing when the condition of the EPB 15 is shifted from the inactivated condition to the transient condition, and the first counter thus reset measures an elapsed time from the point at which the power supply to the motor 16 is commenced to a point at which the EPB 15 starts applying the braking torque to the wheel 10. As an option, an upper limit value of the count value of the first counter may be set to allow the first counter to count the elapsed time longer than the above-mentioned measurement time of the elapsed time.

Then, it is determined at step S14 whether at least any one of the below-mentioned first condition and second condition is satisfied. Specifically, the first condition is that the EPB 15 is in the inactivated condition, and the second condition that the EPB 15 is in the transient condition and the counter value of the first counter is equal to or less than the predetermined value. That is, it is determined at step S14 whether or not the EPB 15 is in the non-braking condition. To this end, the predetermined value may be set to a length of time from the point at which the power supply to the motor 16 has been commenced to the point at which the braking torque starts being applied to the wheel 10 by the EPB 15, based on a result of an experiment or a simulation conducted in advance.

If the EPB 15 is in the inactivated condition, or if the EPB 15 is in the transient condition and the counter value of the first counter is equal to or less than the predetermined value so that the answer of step S14 is YES, the routine progresses to step S15 to determine that the EPB 15 is in the non-braking condition, and thereafter returns. By contrast, if neither the first condition nor the second condition is satisfied so that the answer of step S14 is NO, the routine progresses to step S16 to determine that the EPB 15 is in the braking condition, and thereafter returns.

Thus, it is possible to determine whether or not the EPB15 in in the non-braking condition based on the elapsed time from the timing at which the power supply to the motor 16 is started to apply the braking torque to the wheel 10. Therefore, it is possible to determine a period in which the braking torque is not applied to the wheel 10 and a period in which the braking torque is applied to the wheel 10 in the transient condition of the EPB 15 between the inactivated condition and the activated condition. For this reason, the satisfaction of the condition in which the drive shaft 9 is twisted may be determined accurately.

When the braking torque being applied to the wheel 10 is cancelled, a torsion angle of the drive shaft 9 increases gradually. For example, if an elapsed time from a point at which the braking torque being applied to the wheel 10 was cancelled is short, the drive shaft 9 is twisted only slightly. In this case, if the assist torque is generated by the motor 1, the vehicle Ve may be vibrated undesirably. In order to prevent such undesired vibrations of the vehicle Ve, the torsion of the drive shaft 9 may also be determined based on the elapsed time in which the braking torque is not applied to the wheel 10. That is, the torsion flag may also be turned on in a case that the drive shaft 9 is twisted to a degree at which the assist torque has to be generated by the motor 1 to suppress shocks to be generated when the parking lock mechanism 11 is released.

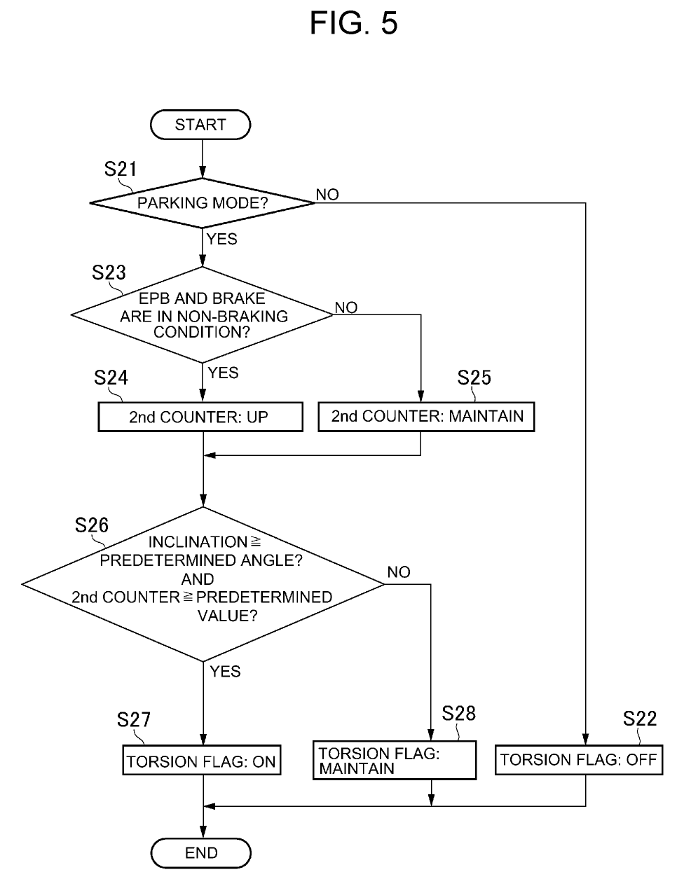

To this end, the routine shown in FIG. 5 is executed. As step S1 of the routine shown in FIG. 3, it is determined at step S21 whether the parking mode is selected. If the parking mode is not selected so that the answer of S21 is NO, the routine progresses to step S22 to turn off the torsion flag representing torsion of the drive shaft 9, as step S2 of the routine shown in FIG. 3. Thereafter, the routine returns. In this case, a count value of an after-mentioned second counter that measures an elapsed time from the point at which both of the EPB 15 and the brake device 14 were brought into the non-braking condition is reset to zero.

By contrast, if the parking mode is selected so that the answer of step S21 is YES, the routine progresses to step S23 to determine whether each of the EPB 15 and the brake device 14 is in the non-braking condition by the brake determiner 30 and the inclination angle determiner 31. As described above, such determination at step S23 may be made by executing the routine shown in FIG. 4.

If each of the EPB 15 and the brake device 14 is in the non-braking condition so that the answer of step S23 is YES, a torsion angle of the drive shaft 9 may be increased. Therefore, if the answer of step S23 is YES, the routine progresses to step S24 to increment a count value of the second counter. By contrast, if at least any one of the EPB 15 and the brake device 14 is applying the braking torque to the wheel 10 so that the answer of step S23 is NO, the routine progresses to step S25 to maintain the count value of the second counter.

Then, it is determined at step S26 whether an absolute value of an inclination angle of the vehicle Ve is equal to or greater than the predetermined angle, and whether the counter value of the second counter is equal to or greater than the predetermined value. That is, it is determined at step S26 whether or not the conditions in which the drive shaft 9 is twisted are satisfied. To this end, the predetermined angle may be set to the predetermined angle employed at step S3 of the routine shown in FIG. 3.

On the other hand, the predetermined value employed at step S26 is a length of an elapsed time from a point at which the braking torque applied to the wheel 10 is cancelled to a point at which the torsion angle of the drive shaft 9 is increased to an angle at which the assist torque has to be generated by the motor 1 to suppress the shock caused by releasing the parking lock mechanism 11. For example, the predetermined value is determined based on a result of an experiment or a simulation conducted in advance. Since a rate of temporal change in the torsion angle of the drive shaft 9 differs depending on an inclination angle of the vehicle Ve, the predetermined value may be a variable which is reduced with an increase in the inclination angle of the vehicle Ve.

If the inclination angle of the vehicle Ve is equal to or greater than the predetermined angle and the count value of the second counter is equal to or greater than the predetermined value so that the answer of step S26 is YES, the routine progresses to step S27 to turn on the torsion flag, and thereafter returns. By contrast, if the inclination angle of the vehicle Ve is less than the predetermined angle, or if the count value of the second counter is less than the predetermined value so that the answer of step S26 is NO, the routine progresses to step S28 to maintain the status of the torsion flag in the previous routine, and thereafter returns.

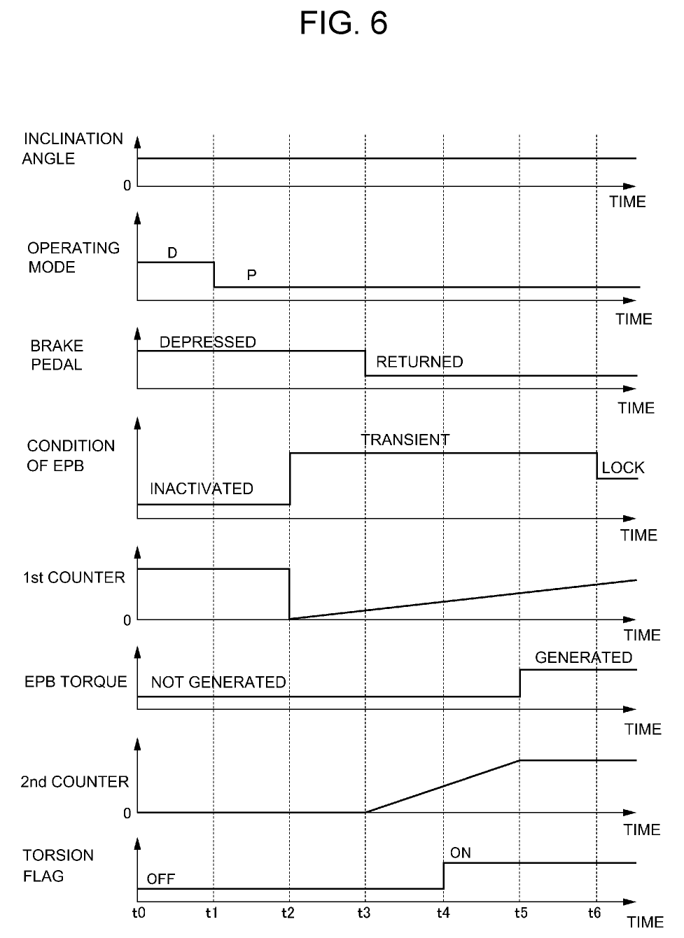

FIG. 6 shows changes in the inclination angle of the vehicle Ve, the operating mode, the state of the brake pedal, the state of the EPB 15, the first counter, the braking torque of the EPB 15, the second counter, and the torsion flag, during execution of the routines shown in FIGS. 4 and 5.

At point t0, the inclination angle of the vehicle Ve is equal to or greater than the predetermined angle. In this situation, the vehicle Ve is in the drive mode and the brake pedal is depressed to stop the vehicle Ve. However, the EPB 15 is still inactivated. In this situation, since the braking torque will act on the wheel 10 after the vehicle Ve is stopped and the upstream section (i.e., a portion close to the motor 1) of the drive shaft 9 is still allowed to rotate, the drive shaft 9 is not twisted.

At point t1, the operating mode is shifted to parking mode, and hence the routine shown in FIG. 5 progresses from step S21 to step S23. In this situation, since the brake pedal is depressed at point t1, the braking torque is applied to the wheel 10 by the brake device 14. Therefore, the routine shown in FIG. 5 further progresses from step S23 to step S25, and hence the counter value of the second counter is maintained to zero.

Since the operating mode is shifted to the parking mode, at point t2, the power supply to the motor 16 is started to activate the EPB 15. Consequently, a condition of the EPB 15, that is, a phase of the EPB 15 is changed from an inactivated phase to a transient phase. In this situation, the routine shown in FIG. 4 progresses from step S11 to step S12 to reset the first counter to zero.

At point t3, the brake pedal is returned so that the braking torque applied to the wheel 10 by the brake device 14 is reduced. In this situation, the count value of the first counter is equal to or less than a predetermined value. Therefore, the routine shown in FIG. 4 progresses from step S14 to step S15, and the ECU 21 determines that the EPB 15 is in the non-braking condition. At the same time, the routine shown in FIG. 5 progresses from step S23 to step S24 to increment the count value of the second counter.

At point t4, the count value of the second counter is increased to the predetermined value or greater. Therefore, the routine shown in FIG. 5 progresses from step S26 to step S27, and consequently the torsion flag is turned on.

At point t5, the count value of the first counter is increased to the predetermined value or greater. Therefore, the ECU 21 determines that the EPB 15 is in the braking condition, and hence the count value of the first counter is maintained constant. Thereafter, at point t6, the wheel 10 is locked by the braking torque applied from the EPB 15.

Thus, the torsion of the drive shaft 9 is determined based on the count value of the length of time in which the braking torque does not act on the wheel 10. Therefore, even if the drive shaft 9 is twisted slightly in a situation where the braking torque is applied to the wheel 10 by the EPB 15 slightly after the timing at which the braking torque being applied to the wheel 10 by the brake device 14 is cancelled, the torsion flag will not be turned on. For this reason, the assist torque will not be generated by the motor 1 when releasing the parking lock mechanism 11. That is, the vehicle Ve will not be vibrated by the assist torque of the motor 1 when the parking lock mechanism 11 is released.

According to the routine shown in FIG. 3, the torsion of the drive shaft 9 is determined based on the fact that neither of the brake device 14 and the EPB 15 apply the braking torque to the wheel 10. However, the drive shaft 9 is twisted by a rotation of the wheel 10. Therefore, the torsion of the drive shaft 9 may also be determined based on the rotation of the wheel 10. To this end, at step S3 of the routine shown in FIG. 3, it may also be determined whether a rotational speed of the wheel 10 detected by the wheel speed sensor 23 is equal to or greater than a predetermined speed, in addition to determine whether an absolute value of the inclination angle of the vehicle Ve is equal to or greater than the predetermined angle.

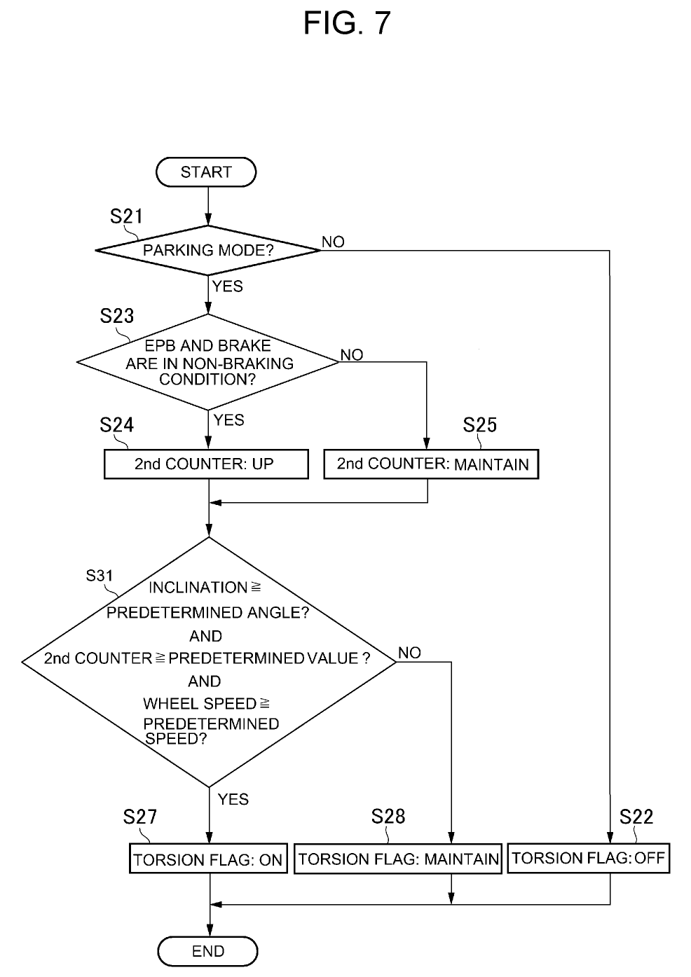

In this case, the routine shown in FIG. 7 is executed. According to the routine shown in FIG. 7, the torsion flag is turned on given that all the conditions of step S3 of the routine shown in FIG. 3 and step S26 of the routine shown in FIG. 5 are satisfied, and that a rotational speed of the wheel 10 is equal to or higher than the predetermined speed. In the following description, detailed explanations for the steps in common with those in FIG. 5 will be omitted.

According to the routine shown in FIG. 7, after incrementing the count value of the second counter at step S24 or after maintaining the count value of the second counter at step S25, the routine progresses to step S31. At step S31, specifically, it is determined whether an absolute value of an inclination angle of the vehicle Ve is equal to or greater than the predetermined angle, whether a count value of the second counter is equal to or greater than the predetermined value, and whether a rotational speed of the wheel 10 is equal to or higher than the predetermined speed.

If the above-mentioned conditions are satisfied so that the answer to step S31 is YES, the routine progresses to step S27 to turn on the torsion flag, and thereafter returns. By contrast, if at least any of the above-mentioned conditions is/are not satisfied so that the answer of step S31 is NO, the routine progresses to step S28 to maintain the status of the torsion flag in the previous routine.

Thus, according to the routine shown in FIG. 7, the torsion of the drive shaft 9 is determined based on the fact that the rotational speed of the wheel 10 is equal to or higher than the predetermined speed. Therefore, the torsion of the drive shaft 9 will not be determined erroneously in a situation where the wheel 10 is not allowed to rotate by a traveling resistance and frictional resistances of rotary members arranged upstream of the wheel 10. For this reason, the assist torque will not be generated by the motor 1 when the parking lock mechanism 11 is released. That is, the vehicle Ve will not be vibrated by the assist torque of the motor 1 when the parking lock mechanism 11 is released. In other words, the torsion of the driveshaft 9 may be determined based on the actual behavior of the vehicle Ve. Therefore, it is possible to improve the determination accuracy of the torsion of the drive shaft 9.

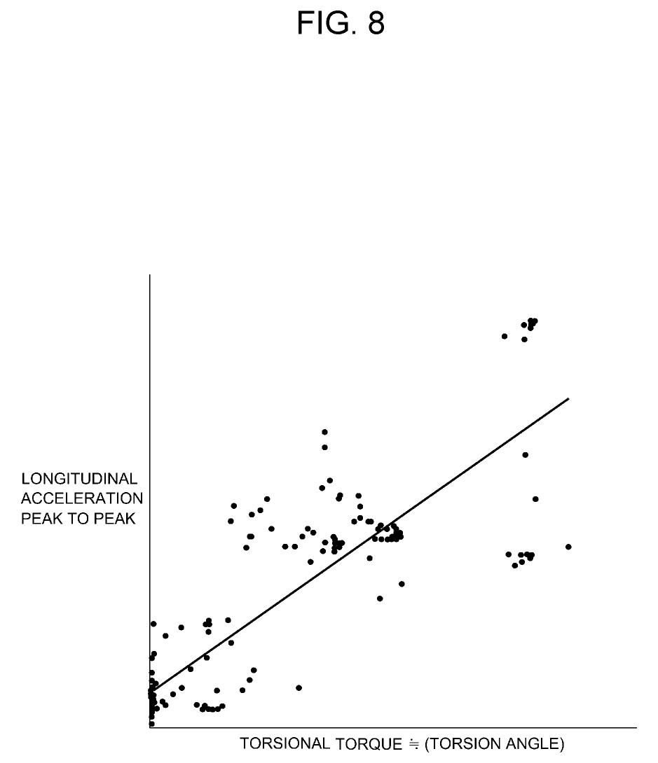

When the drive shaft 9 is twisted, a reaction torque counteracting the torsional torque of the drive shaft 9 is generated in accordance with an elastic modulus of the drive shaft 9, and consequently the vehicle Ve is vibrated in the longitudinal direction. A difference between a maximum value and a minimum value of the acceleration in the longitudinal direction of the vehicle Ve in this situation is correlated with a torsional torque of the drive shaft 9. FIG. 8 shows a result of an experimentation conducted to examine the relation between: the difference between the maximum value and the minimum value of the longitudinal acceleration after stopping the rotation of the intermediate shaft 5 by the parking lock mechanism 11; and the torsional torque (i.e., the torsion angle) of the drive shaft 9. In FIG. 8, the horizontal axis represents the torsional torque of the drive shaft 9, and the vertical axis represents the difference between the maximum value and the minimum value of the longitudinal acceleration of the vehicle Ve. In addition, in FIG. 8, experimental values of the differences between the maximum value and the minimum value of the longitudinal acceleration with respect to the torsional torque are plotted, and a diagonal line indicates an approximate value of those plotted values.

As can be seen from FIG. 8, the difference between the maximum value and the minimum value of the longitudinal acceleration after locking the intermediate shaft 5 by the parking lock mechanism 11 increases with an increase in the torsion angle of the drive shaft 9. After locking the intermediate shaft 5 by the parking lock mechanism 11, an amplitude of the longitudinal acceleration decreases gradually. That is, the amplitude of the first cycle after locking the intermediate shaft 5 by the parking lock mechanism 11 contains the maximum value and the minimum value.

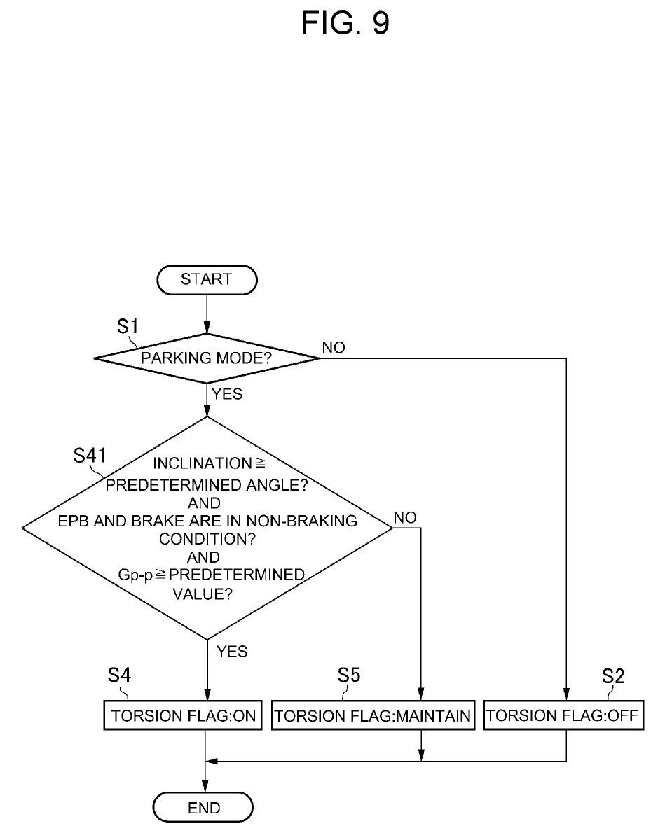

Therefore, the torsion of the drive shaft 9 may also be determined based on the difference between the maximum value and the minimum value of the longitudinal acceleration of the vehicle Ve after locking the intermediate shaft 5 by the parking lock mechanism 11. To this end, the routine shown in FIG. 9 is executed. In the following description, detailed explanations for the steps in common with those in FIG. 3 will be omitted.

According to the routine shown in FIG. 9, if the parking mode is selected so that the answer of step S1 is YES, the routine progresses to step S41 to determine whether an absolute value of an inclination angle of the vehicle Ve is equal to or greater than the predetermined angle, whether each of the EPB 15 and the brake device 14 is in the non-braking condition, and whether a difference (Gp-p) between the maximum value and the minimum value of the longitudinal acceleration of the vehicle Ve is equal to or greater than a predetermined value. For this purpose, the predetermined value of the difference between the maximum value and the minimum value of the longitudinal acceleration may be determined based on a magnitude (or amplitude) of the vibration by which the driver senses the vibration when releasing the parking lock mechanism 11. In addition, the longitudinal acceleration of the vehicle Ve may be detected by the acceleration sensor 22.

If the absolute value of the inclination angle of the vehicle Ve is equal to or greater than the predetermined angle, each of the EPB 15 and the brake device 14 is in the non-braking condition, and the difference between the maximum value and the minimum value of the longitudinal acceleration of the vehicle Ve is equal to or greater than the predetermined value so that the answer of step S41 is YES, the routine progresses to step S4 to turn on the torsion flag. Thereafter, the routine returns. By contrast, if the absolute value of the inclination angle of the vehicle Ve is less than the predetermined angle, the EPB 15 or the brake device 14 is in the braking condition, or the difference between the maximum value and the minimum value of the longitudinal acceleration of the vehicle Ve is less than the predetermined value so that the answer of step S41 is NO, the routine progresses to step S5 to maintain the status of the torsion flag in the previous routine. Thereafter, the routine returns.

Such determination as to whether the difference between the maximum value and the minimum value of the longitudinal acceleration of the vehicle Ve is equal to or greater than the predetermined value may be added to the determination of step S31 in the routine shown in FIG. 7. Alternatively, it may also be determined at step S31 whether the difference between the maximum value and the minimum value of the longitudinal acceleration of the vehicle Ve is equal to or greater than the predetermined value, instead of determining whether the rotational speed of the wheel 10 is equal to or greater than the predetermined speed.

Thus, it is also possible to determine the torsion of the drive shaft 9 based on the longitudinal acceleration of the vehicle Ve detected by the acceleration sensor 22. That is, the inclination angle of the vehicle Ve and the longitudinal acceleration for determining the torsion of the drive shaft 9 may be obtained based on the detection signal transmitted from the acceleration sensor 22. Therefore, it is not necessary to arrange an additional sensor for determining the torsion of the drive shaft 9. For this reason, the size of the vehicle Ve is not increased by the additional sensor, and in addition, it is possible to prevent complication of data-processing of the sensor.

The control system according to the exemplary embodiment of the present disclosure is further configured not to perform the determination of the torsion of the drive shaft 9, in the event of a failure of the brake device 14 or a communication error between the B-ECU 27 and the ECU 21, or in the event of a failure of the EPB 15 or a communication error between the EPB-ECU 26 and the ECU 21. Specifically, when any of the above-described failures or communication failures occurs, an inhibition flag is turned on and the torsion flag is turned off.

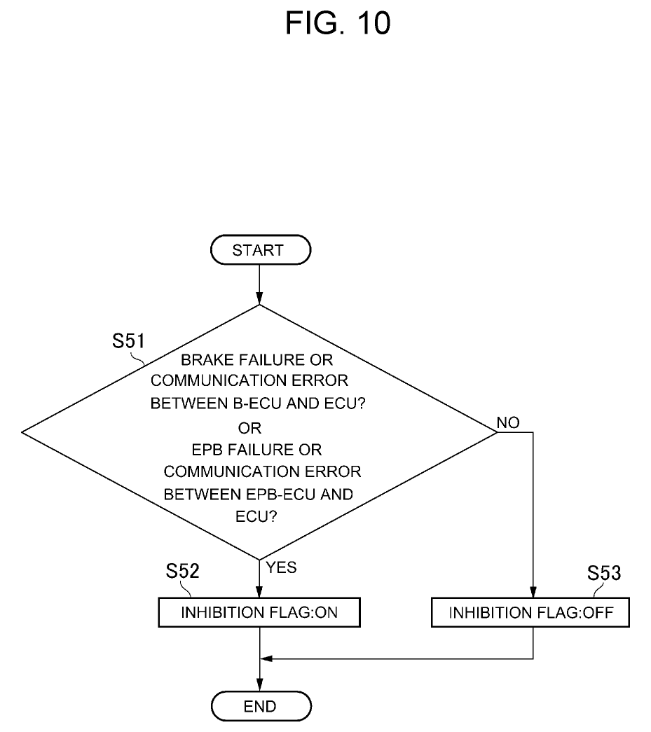

To this end, the routine shown in FIG. 10 is executed. At step S51, it is determined whether the brake device 14 experiences a failure or a communication error occurs between the B-ECU 27 and the ECU 21, or whether the EPB 15 experiences a failure or a communication error occurs between the EPB-ECU 26 and the ECU 21. Such determination at step S51 may be made by the abnormality determiner 34. That is, it is determined at step S51 whether a signal representing a failure of the brake device 14 or the EPB 15 is transmitted from the EPB-ECU 26 or the B-ECU 27 to the ECU 21, or whether there is a difficulty in the communication between the EPB-ECU 26 or the B-ECU 27 and the ECU 21.

If at least any one of the brake device 14 and the EPB 15 experiences a failure, or if the communication error occurs between the EPB-ECU 26 or the B-ECU 27 and the ECU 21 so that the answer of step S51 is YES, the routine progresses to step S52 to turn on the inhibition flag, and thereafter returns. By contrast, if both of the brake device 14 and the EPB 15 function properly and the B-ECU 27 and the EPB-ECU 26 may be communicated properly with the ECU 21 so that the answer of step S51 is NO, the routine progresses to step S53 to turn off the inhibition flag, and thereafter returns.

As an optional extra, it may also be determined whether the inhibition flag is off at step S1 of the routine shown in FIG. 3, step S21 of the routine shown in FIG. 5, step S21 of the routine shown in FIG. 7, and step S1 of the routine shown in FIG. 9. In this case, if the inhibition flag is on so that the answer of any of these steps is NO, the torsion flag is turned off.

Thus, the torsion flag is turned off in the event of a failure the brake device 14 or the EPB 15, or in the event of a communication error between the B-ECU 27 or the EPB-ECU 26 and the ECU 21, that is, in the situation where the braking torque cannot be applied appropriately to the wheel 10 by the brake device 14 or the EPB15, or in the situation where the braking torque applied to the wheel 10 by the brake device 14 or the EPB 15 cannot be determined. According to the exemplary embodiment of the present disclosure, therefore, the assist torque is not generated unnecessarily by the motor 1, and the vehicle Ve will not be vibrated by such unnecessary assist torque.

Although the above examples of the present disclosure have been described, it will be understood by those skilled in the art that the present disclosure should not be limited to the described examples, and various changes and modifications can be made within the scope of the present disclosure. For example, the control system according to the exemplary embodiment of the present disclosure may also be applied to an electric vehicle in which torque is distributed from one motor to a pair of front wheels or rear wheels or to all wheels. In addition, the control system according to the exemplary embodiment of the present disclosure may also be applied to a hybrid-vehicle in which a prime mover includes a motor and an engine.

In addition, a configuration to join the drive shaft 9 to the motor 1, and the rotary member whose rotation is stopped by the parking lock mechanism 11 are not limited to those illustrated in FIG. 1. Further, the EPB 15 may be omitted from the vehicle Ve. In this case, the torsion flag is turned on and off based on whether or not the braking torque is applied to the wheel 10 by the brake device 14.

What is claimed is:

1. A control system for a vehicle, comprising:
a drive shaft in which one end thereof is joined to a wheel;
a motor that applies a torque to the drive shaft;
a parking lock mechanism that stops a rotation of a predetermined rotary member arranged between the motor and the drive shaft by locking the rotary member, and that allows the rotary member to rotate by releasing the rotary member; and
a brake device that applies a braking torque to the wheel,
the control system comprising:
a controller that controls the motor,
wherein the controller comprises:
a parking determiner that determines whether the rotation of the rotary member is stopped by the parking lock mechanism;
a brake determiner that determines whether the braking torque applied to the wheel by the brake device is equal to or less than a predetermined torque;
an inclination angle determiner that determines whether an inclination angle of the vehicle in a pitching direction is equal to or greater than a predetermined angle;
a torsion determiner that determines a torsion of the drive shaft in a case that the rotation of the rotary member is stopped by the parking lock mechanism, that the braking torque applied to the wheel by the brake device is equal to or less than the predetermined torque, and that the inclination angle of the vehicle in the pitching direction is equal to or greater than the predetermined angle; and
a motor controller that controls the motor to generate an assist torque in a direction to counteract a torsional torque acting on the drive shaft when allowing the rotary member to rotate by the parking lock mechanism, in a case that the torsion of the drive shaft is determined.

2. The control system for the vehicle as claimed in claim 1, wherein the torsion determiner is configured to determine the torsion of the drive shaft in a case that the rotation of the rotary member is stopped by the parking lock mechanism, and that a length of time in which the braking torque applied to the wheel by the brake device is equal to or less than a predetermined torque is equal to or longer than a predetermined period of time.

3. The control system for the vehicle as claimed in claim 2, wherein the predetermined period of time is set shorter with an increase in the inclination angle of the vehicle.

4. The control system for the vehicle as claimed in claim 1, further comprising:
a wheel speed detector that detects a rotational speed of the wheel,
wherein the torsion determiner is configured to determine the torsion of the drive shaft in a case that the rotational speed of the wheel after stopping the rotation of the rotary member by the parking lock mechanism is equal to or higher than a predetermined speed.

5. The control system for the vehicle as claimed in claim 1, further comprising:
an acceleration detector that detects a longitudinal acceleration of the vehicle,
wherein the torsion determiner is configured to determine the torsion of the drive shaft in a case that a difference between a maximum value and a minimum value of the acceleration of the vehicle after stopping the rotation of the rotary member by the parking lock mechanism is equal to or greater than a predetermined value.

6. A control system for a vehicle, comprising:
a drive shaft in which one end thereof is joined to a wheel;
a motor that applies a torque to the drive shaft; and
a parking lock mechanism that stops a rotation of a predetermined rotary member arranged between the motor and the drive shaft by locking the rotary member, and that allows the rotary member to rotate by releasing the rotary member;
the control system comprising:
a wheel speed detector that detects a rotational speed of the wheel; and
a controller that controls the motor,
wherein the controller comprises:
a parking determiner that determines whether the rotation of the rotary member is stopped by the parking lock mechanism;
an inclination angle determiner that determines whether an inclination angle of the vehicle in a pitching direction is equal to or greater than a predetermined angle;
a rotational speed determiner that determines whether a rotational speed of the wheel is equal to or higher than a predetermined speed;
a torsion determiner that determines a torsion of the drive shaft in a case that the rotation of the rotary member is stopped by the parking lock mechanism, that the inclination angle of the vehicle in the pitching direction is equal to or greater than the predetermined angle, and that the rotational speed of the wheel after stopping the rotation of the rotary member by the parking lock mechanism is equal to or higher than the predetermined speed; and
a motor controller that controls the motor to generate an assist torque in a direction to counteract a torsional torque acting on the drive shaft when allowing the rotary member to rotate by the parking lock mechanism, in a case that the torsion of the drive shaft is determined.

7. A control system for a vehicle, comprising:
a drive shaft in which one end thereof is joined to a wheel;
a motor that applies a torque to the drive shaft; and
a parking lock mechanism that stops a rotation of a predetermined rotary member arranged between the motor and the drive shaft by locking the rotary member, and that allows the rotary member to rotate by releasing the rotary member;
the control system comprising:
an acceleration detector that detects a longitudinal acceleration of the vehicle; and
a controller that controls the motor,
wherein the controller comprises:
a parking determiner that determines whether the rotation of the rotary member is stopped by the parking lock mechanism;
an inclination angle determiner that determines whether an inclination angle of the vehicle in a pitching direction is equal to or greater than a predetermined angle;
a torsion determiner that determines a torsion of the drive shaft in a case that the rotation of the rotary member is stopped by the parking lock mechanism, that the inclination angle of the vehicle in the pitching direction is equal to or greater than the predetermined angle, and that a difference between a maximum value and a minimum value of the acceleration of the vehicle after stopping the rotation of the rotary member by the parking lock mechanism is equal to or greater than a predetermined value; and
a motor controller that controls the motor to generate an assist torque in a direction to counteract a torsional torque acting on the drive shaft when allowing the rotary member to rotate by the parking lock mechanism, in a case that the torsion of the drive shaft is determined.

8. The control system for a vehicle as claimed in claim 1,
wherein the controller further comprises an abnormality determiner that determines a fact that the braking torque applied to the wheel by the brake device is out of control, and
the torsion determiner is configured not to determine the torsion of the drive shaft in a case that the braking torque applied to the wheel by the brake device is out of control.

9. The control system for a vehicle as claimed in claim 2,
wherein the controller further comprises an abnormality determiner that determines a fact that the braking torque applied to the wheel by the brake device is out of control, and
the torsion determiner is configured not to determine the torsion of the drive shaft in a case that the braking torque applied to the wheel by the brake device is out of control.

10. The control system for a vehicle as claimed in claim 3,
wherein the controller further comprises an abnormality determiner that determines a fact that the braking torque applied to the wheel by the brake device is out of control, and
the torsion determiner is configured not to determine the torsion of the drive shaft in a case that the braking torque applied to the wheel by the brake device is out of control.

11. The control system for a vehicle as claimed in claim 4,
wherein the controller further comprises an abnormality determiner that determines a fact that the braking torque applied to the wheel by the brake device is out of control, and
the torsion determiner is configured not to determine the torsion of the drive shaft in a case that the braking torque applied to the wheel by the brake device is out of control.

12. The control system for a vehicle as claimed in claim 5,
wherein the controller further comprises an abnormality determiner that determines a fact that the braking torque applied to the wheel by the brake device is out of control, and
the torsion determiner is configured not to determine the torsion of the drive shaft in a case that the braking torque applied to the wheel by the brake device is out of control.
